(19) United States
(12) Patent Application Publication
(10) Pub. No.: US 2024/0371112 A1
(43) Pub. Date: Nov. 7, 2024

(54) AUGMENTED REALITY CAPTURE

(71) Applicant: Meta Platforms Technologies, LLC, Menlo Park, CA (US)

(72) Inventors: Zhiqing Rao, Redmond, WA (US); Eugene Gorbatov, Sammamish, WA (US); Morgyn Taylor, Danville, CA (US)

(21) Appl. No.: 18/313,185

(22) Filed: May 5, 2023

(51) Int. Cl. G06T 19/00; H04N 13/383

(52) U.S. Cl. CPC G06T 19/006; H04N 13/383

(57) ABSTRACT

In one embodiment, a method includes accessing, from a client system associated with a first user, multiple surfaces in an artificial reality scene, wherein the multiple surfaces are projected for display to the first user based on an eye pose of the first user; capturing a frame of the real-world environment while displaying the artificial reality scene to the first user, wherein the captured frame of the real-world environment is associated with a camera pose; reprojecting the multiple surfaces based on the camera pose; generating an aligned artificial reality scene based on the reprojected multiple surfaces and the captured frame of the real-world environment; and sending the aligned artificial reality scene to a second user for display.

### TECHNICAL FIELD

This disclosure generally relates to data processing of an artificial reality environment. and in particular relates to systems and methods for capturing augmented reality scenes.

### BACKGROUND

Augmented Reality (AR) effects are computer-generated visual effects (e.g., images and animation) that are superimposed or integrated into a user's view of a real-world scene. Certain AR effects may be configured to track objects in the real world. For example, a computer-generated unicorn may be placed on a real-world table as captured in a video. As the table moves in the captured video (e.g., due to the camera moving or the table being carried away), the generated unicorn may follow the table so that it continues to appear on top of the table. To achieve this effect, an AR application may use tracking algorithms to track the positions and/or orientations of objects appearing in the real-world scene and use the resulting tracking data to generate the appropriate AR effect. Since AR effects may augment the real-world scene in real-time or near real-time while the scene is being observed, tracking data may need to be generated in real-time or near real-time so that the AR effect appears as desired.

AR may provide users with an immersive experience by overlaying virtual objects on top of real-world environments. The users of AR devices may want to share AR experience with other AR users or two-dimensional display devices (e.g., smartphone, tablet, laptop) users as an essential part of social networking activities. One of the limitations of AR devices is that the AR display may not be seen by multiple users at a time, which may lead to difficulties in sharing the AR experience with others. Like Virtual Reality (VR) devices, AR devices typically rely on a display that can be viewed by the user wearing the AR device but not be seen by multiple users. This limitation has created a need for a more efficient, cost-effective, and functional system and method for sharing AR experiences.

### SUMMARY OF PARTICULAR EMBODIMENTS

Particular embodiments described herein relate to systems and methods for capturing AR scenes and sharing the captured AR scenes with other users. The method may include having an AR headset to reproject AR surfaces to a viewpoint to the user's eye when displaying AR content on the AR headset. When capturing the AR content, the AR surfaces may be reprojected to the viewpoint of a POV camera of the AR headset. The projected result may be overlaid on top of the captured frame. The captured image or video, including AR content and real-world information, may be shared with other users for playback. The AR capture may comprise two modes: a two-dimensional (2D) capturing mode and a three-dimensional (3D) AR capturing mode. In the 2D video capture mode, a late-latching reprojection engine may disable all display corrections (e.g., distortion correction, chromatic aberration correction) used for displaying the virtual content when displaying to the user. The late-latching reprojection engine may use the stabilized camera pose to reproject the AR surfaces into a 2D rectilinear frame buffer. The 2D rectilinear frame buffer may be video encoded afterward. In the 3D AR capture mode, the 2D and 3D surfaces may be 2D composited into a single frame buffer. Each individual surface 3D pose, surface offset, and size in the single frame buffer, head pose, eye pose, and camera pose may be recorded as metadata for later 3D playback to achieve a 3D sharing experience. The AR surfaces rendered for a particular viewpoint for 3D AR objects may be saved in a texture format to be placed in a 2D image for easy encoding. During playback, the viewer could interact with the AR surfaces and/or see them from slightly different angles.

In particular embodiments, a computing system may access a plurality of surfaces in an artificial reality scene from a client system associated with a first user. The plurality of surfaces may be rendered by a GPU of the client system associated with the first user. The plurality of surfaces may be projected for display to the first user based on an eye pose of the first user. The computing system may capture a frame of the real-world environment while displaying the artificial reality scene to the first user, wherein the captured frame of the real-world environment is associated with a camera pose. The computing system may reproject the plurality of surfaces based on the camera pose. The computing system may generate an aligned artificial reality scene based on the reprojected plurality of surfaces and the captured frame of the real-world environment. The computing system may send the aligned artificial reality scene to a second user for display. The plurality of surfaces may be associated with a first timestamp, and the captured frame of the real-world environment may be associated with a second timestamp that is different from the first timestamp. The plurality of surfaces may be previously rendered at a first frame rate, and the reprojected plurality of surfaces may be generated at a second frame rate that is higher than the first frame rate. The computing system may enable one or more display corrections such as distortion correction and chromatic aberration correction when displaying the AR content to the first user. When reprojecting the plurality of surfaces based on the camera pose during AR capture, the computing system may disable the one or more display corrections and may directly reproject the plurality of surfaces without corrections. The computing system may reproject the plurality of surfaces into a two-dimensional rectilinear frame buffer based on the camera pose.

In particular embodiments, the computing system may record positioning metadata associated with each of the plurality of surfaces in a 3D capture mode. The computing system may store the plurality of surfaces to a single frame buffer. The computing system may also store the positioning metadata. The computing system may reposition the stored plurality of surfaces based on the positioning metadata for three-dimensional playback for the first user. In particular embodiments, the computing system may encode the single frame buffer and the stored positioning metadata and may then send the encoded single frame buffer and the encoded positioning metadata to a second user for three-dimensional playback. The positioning metadata comprises a surface three-dimensional pose in the single frame buffer, a surface offset in the single frame buffer, a surface size in the single frame buffer, a surface scaling factor in the single frame buffer, head pose of the first user, eye pose of the first user, and a camera pose. The computing system may provide a playback application for the AR capture playback. The playback application may access the positioning metadata and the stored plurality of surfaces and their corresponding 3D world pose for the first user and/or the second user to see the 3D experience during playback. The plurality of surfaces may be stored in a texture format. The plurality of surfaces may be interactable during the three-dimensional playback.

Certain technical challenges exist for capturing and sharing AR experiences with multiple users. One technical challenge may include the limited power budget for an AR device (e.g., AR glass) so that the extremely low power AR device may be unable to re-render the virtual content for AR capture. The solution presented by the embodiments disclosed herein to address this challenge may be reprojecting the AR content based on previously rendered AR surfaces instead of re-rendering AR content. Another technical challenge may include the virtual content may not be directly overlaid onto an image captured by the camera of the AR device for AR capture due to an offset of the user's eye and the camera of the AR device, which may result in the virtual content appearing incorrectly overlaid or misaligned with the real-world image. The solution presented by the embodiments disclosed herein to address this challenge may be reprojecting the AR surfaces for the AR contents based on a camera pose when capturing the real-word image.

Certain embodiments disclosed herein may provide one or more technical advantages. A technical advantage of the embodiments may include significantly reducing system cost in power budget by projecting the augmented reality surfaces instead of re-rendering the virtual content when capturing the virtual content for playback or sharing other users. Another technical advantage of the embodiments may include enabling sharing three-dimensional virtual contents with other users in an artificial reality environment. Certain embodiments disclosed herein may provide none, some, or all of the above technical advantages. One or more other technical advantages may be readily apparent to one skilled in the art in view of the figures, descriptions, and claims of the present disclosure.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example virtual reality system worn by a user.

FIG. 1B illustrates an example augmented reality system.

FIG. 2 illustrates an example display correction for augmented reality display.

FIG. 3 illustrates an example architecture of the augmented reality system.

FIG. 4 illustrates an example two-dimensional (2D) AR capturing mode for storing AR surfaces.

FIG. 5 illustrates an example three-dimensional (3D) AR capturing mode for storing AR surfaces.

FIG. 6 illustrates an example method for capturing AR scenes and sharing the captured AR scenes with other users.

FIG. 7 illustrates an example network environment associated with an AR system.

FIG. 8 illustrates an example computer system.

### DESCRIPTION OF EXAMPLE EMBODIMENTS

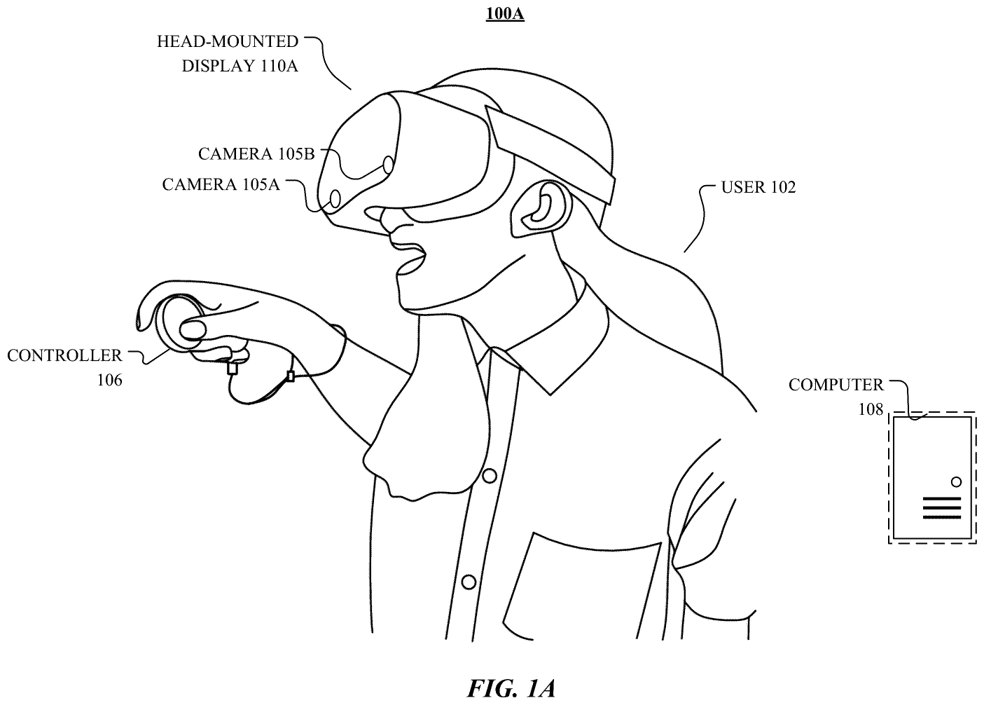

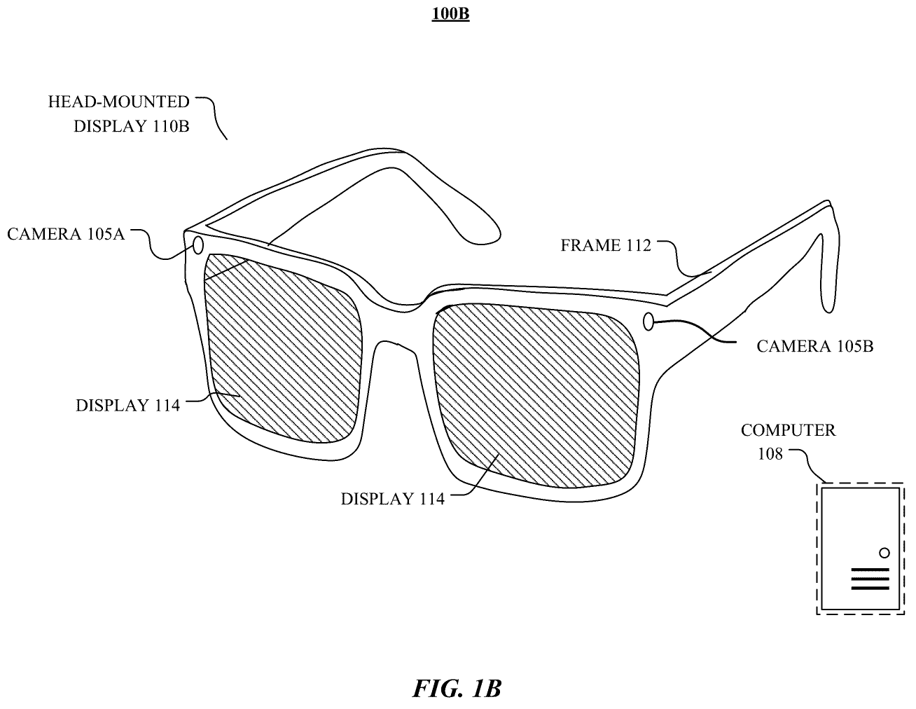

FIG. 1A illustrates an example of a virtual reality system 100A worn by a user 102. In particular embodiments, the virtual reality system 100 may comprise a head-mounted VR display device 110A, a controller 106, and one or more computing systems 108. The VR display device 110A may be worn over the user's eyes and provide visual content to the user 102 through internal displays (not shown). The VR display device 110A may have two separate internal displays, one for each eye of the user 102 (single display devices are also possible). In particular embodiments, the VR display device 110A may comprise one or more external-facing cameras, such as the two forward-facing cameras 105A and 105B, which can capture images and videos of the real-world environment. As illustrated in FIG. 1A, the VR display device 110A may completely cover the user's field of view. By being the exclusive provider of visual information to the user 102, the VR display device 110A achieves the goal of providing an immersive artificial-reality experience. One consequence of this, however, is that the user 102 may not be able to see the physical (real-world) environment surrounding the user 102, as their vision is shielded by the VR display device 110A. As such, the passthrough feature described herein may be technically advantageous for providing the user with real-time visual information about their physical surroundings.

FIG. 1B illustrates an example augmented reality (AR) system 100B. The augmented reality system 100B may include a head-mounted display AR display device 110B comprising a frame 112, one or more displays 114, and one or more computing systems 108. The AR display device 110B may be worn over the user's eyes (e.g., like eyeglasses) and provide visual content to a user 102 (not shown) through displays 114. The one or more displays 114 may be transparent or translucent allowing a user wearing the AR display device 110B to look through the displays 114 to see the real-world environment and displaying visual artificial reality content to the user at the same time. The AR display device 110B may include an audio device that may provide audio artificial reality content to users. The AR display device 110B may include one or more external-facing cameras, such as the two forward-facing cameras 105A and 105B, which can capture images and videos of the real-world environment. The AR display device 110B may include an eye tracking system to track the vergence movement of the user wearing the AR display device 110B. The augmented reality system 100B may further include a controller 106 (not shown) comprising a trackpad and one or more buttons. The controller 106 may receive inputs from users and relay the inputs to the computing system 108. The controller 106 may also provide haptic feedback to users. The computing system 108 may be connected to the AR display device 110B and the controller through cables or wireless connections. The computing system 108 may control the AR display device 110B and the controller to provide the augmented reality content to and receive inputs from users. The computing system 108 may be a standalone host computer system, an on-board computer system integrated with the AR display device 110B, a mobile computing device, or any other hardware platform capable of providing artificial reality content to and receiving inputs from users.

AR technologies provide the possibilities for users to interact with virtual digital content in the users' physical environment. However, the sharing of AR experiences is limited due the fact that the AR display may not be seen by multiple users at the same time as traditional 2D displays such as screen monitors and smartphones. AR capture may be desired as a necessary tool for sharing AR experiences with other AR users and non-AR users. AR capture may enable users to share their AR experiences with others. The capture of AR experiences allows users to record and share their interactions with the virtual content in their physical environment, which may create an opportunity for other users to experience the same AR content regardless of location or access to AR devices.

The system and method to support sharing of AR experiences may require AR capture, including image and video capture, real-time casting, and three-dimensional (3D) experience playback. Image and video capture may allow users to take pictures and videos of the AR experiences they are viewing, which they can then share with others. Real-time casting may enable users to share their AR experiences in real-time with other users, allowing other users to view the same experience simultaneously. 3D experience playback may allow the users to revisit their AR experiences in three dimensions, further enhancing the immersive experience. In order to fully capture and share a comprehensive AR experience with other users, the process of AR capturing may need to encompass graphics capturing, user's eye pose capturing, AR device camera pose capturing, and audio capturing. Graphics capturing may include capturing and recording the visual elements of the AR environment, such as 3D models, textures, and animations to recreate the AR scene. User eye pose capturing may include capturing the precise position and orientation of the user's eyes concerning the AR content, allowing for accurate perspective and depth perception. AR device (e.g., AR glass) camera pose capturing may include capturing the position and orientation of the camera on the AR device, which is used to capture the user's perspective of the AR environment. Audio capturing may include capturing the spatial audio and other sound elements within the AR environment, such as ambient sounds and voice interactions, to provide a complete sensory experience for users when sharing the AR content with other users.

AR devices (e.g., AR glass) may have a low power budget since the AR devices may be designed to be lightweight and portable. The low power budget of the AR devices may limit the ability to re-render AR content for AR capture. In AR devices, the user's eye and a Point of View (POV) camera used for the AR capture may be not in identical positions, where the user's eye is positioned at a fixed distance from the lens, whereas the POV camera may be located slightly offset from the user's eye. The physical world may be captured based on the POV camera pose while the virtual content is rendered based on the user's eye pose. Capturing AR content with the offset between the user's eye and the POV camera may require calibration and position alignment to ensure that the recorded content is based on an identical pose. In AR capture, a 3D experience may be desired to accurately represent the user's perspective and spatial positioning of virtual objects in the physical environment. When sharing AR experiences with other users, the other users may be able to view and interact with the virtual content in a way similar to the original user's experience, creating a more immersive and engaging experience for the viewer. The captured AR content may be in a 2D video format for traditional 2D display users for playback. There may be differences between general 2D videos and AR display. For example, AR display may require display correction such as distortion correction, chromatic aberration correction, and non-uniformity corrections to ensure that the virtual objects are displayed accurately in the physical environment. In contrast, the 2D video does not require such display corrections.

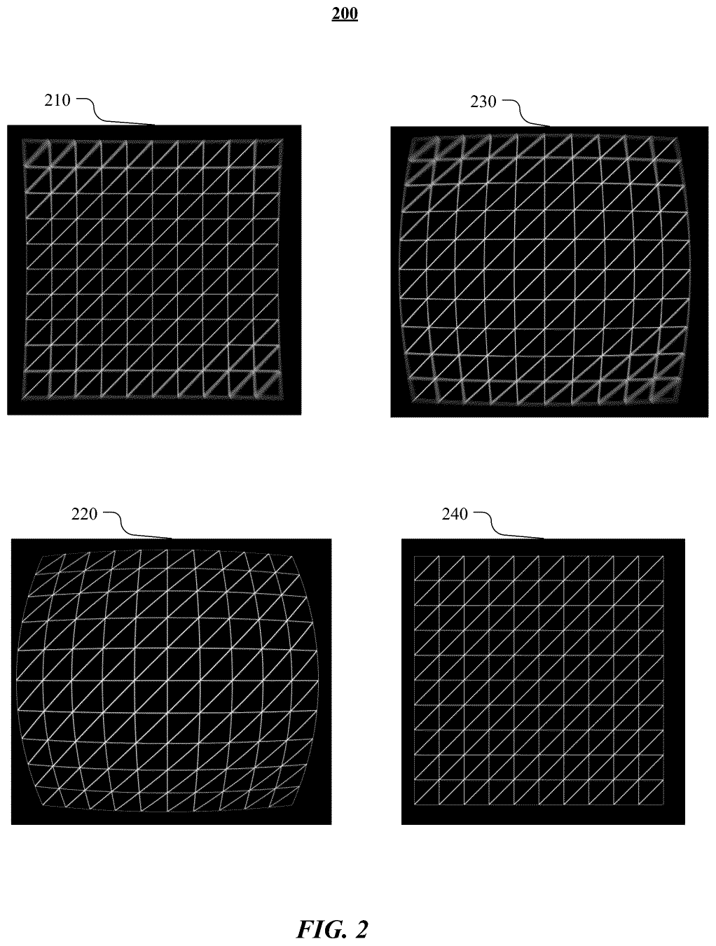

FIG. 2 illustrates an example display correction for augmented reality display. Displaying AR content on AR devices may cause blurry and distorted images. For example, image 210 shows an AR display that may need chromatic aberration correction; image 220 shows an AR display that may need distortion correction; image 230 shows an AR display that may need both chromatic aberration correction and distortion correction; image 240 may not need corrections. The chromatic aberration effect may not be seen accurately in greyscale images. For example, chromatic aberration may appear as a soft, blurred halo around the edges of the object in greyscale images. In color images, the chromatic aberration may appear as color fringes around the edges of object.

AR display and 2D videos may be generated at different resolutions. AR displays may have a higher resolution than 2D videos, which may allow for more detailed and realistic imagery to be rendered. Additionally, the frame rates of AR displays and 2D videos may be different, with AR displays may have a higher frame rate to provide smoother and more seamless motion tracking. Another difference between the AR display and 2D videos is the color space used to produce the images. AR displays may use a wider color gamut encoded in a particular way that may be suitable for AR devices than 2D videos, allowing for more vivid and accurate colors to be displayed. Additionally, 2D videos may require stabilization through the use of graphics and spatial and temporal alignment of video pixels, which may be necessary to ensure that the video is smooth and stable for the viewers. The differences between the general 2D videos and AR displays may comprise the need for corrections in AR displays, differences in resolution, frame rate, and color space, and the need for stabilization in 2D video. The differences may be taken into consideration when capturing and sharing AR content.

In particular embodiments, the computing system 108 may capture AR scenes and share the captured AR scenes with other users. The computing system 108 may have an AR display device 110B to reproject AR surfaces to a viewpoint to the user's eye when displaying AR content on the AR display device 110B. When capturing the AR content, the AR surfaces may be reprojected to the viewpoint of a POV camera 105A and/or 105B of the AR display device 110B. The computing system 108 may overlay the projected result on top of the captured frame. The user 102 may share the captured image or video, including AR content and real-world information with other users for playback. The AR capture may comprise two modes: a two-dimensional (2D) capturing mode and a three-dimensional (3D) AR capturing mode. In the 2D video capture mode, the computing system 108 may comprise a late-latching reprojection engine that may disable all display corrections (e.g., distortion correction, chromatic aberration correction) used for displaying the virtual content when displaying to the user. The late-latching reprojection engine may use the stabilized camera to reproject the AR surfaces into a 2D rectilinear frame buffer. The computing system 108 may then encode the 2D rectilinear frame buffer afterward. In the 3D AR capture mode, the computing system 108 may composite the 2D and 3D surfaces in textures into a single frame buffer. Each individual surface 3D pose, surface offset, and size in the single frame buffer, head pose, eye pose, and camera pose may be recorded as metadata for later 3D playback to achieve a 3D sharing experience. The AR surfaces rendered for a particular viewpoint for 3D AR objects may be saved in a texture format to be placed in a 2D image for easy encoding. During playback, the viewer could interact with the AR surfaces and/or see them from slightly different angles. Although this disclosure describes AR capture in a particular manner, this disclosure contemplates AR capture in any suitable manner.

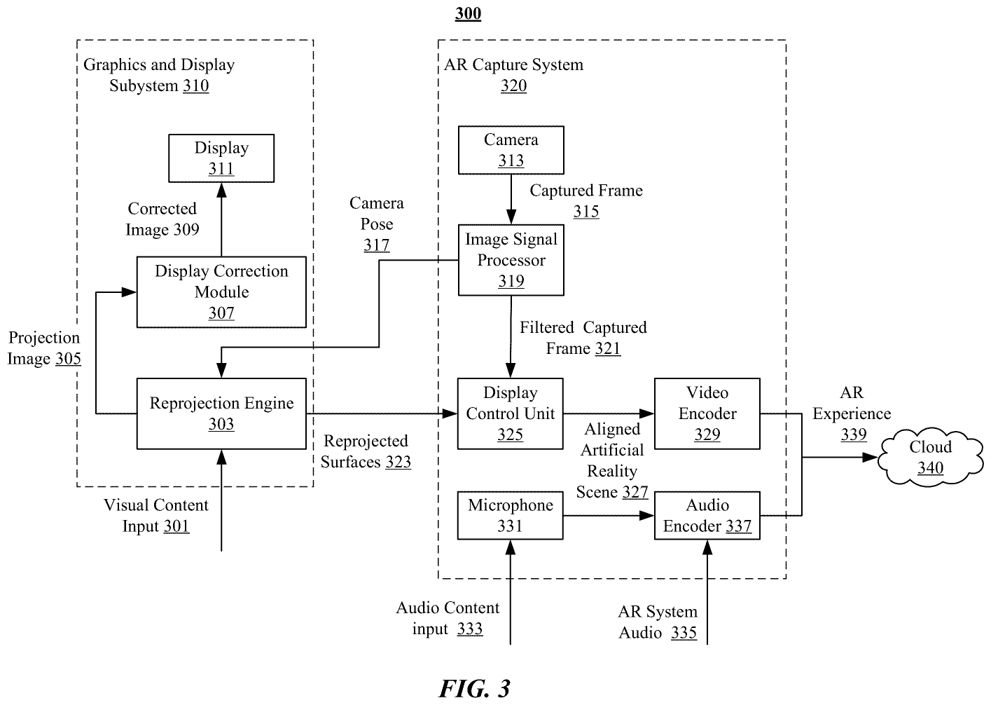

FIG. 3 illustrates an example architecture of the augmented reality system. In particular embodiments, the computing system 108 may comprise a graphics and display subsystem 310 for displaying content to a first user. The first user may be the original viewer of AR content and may want to capture and share the AR content on social media and/or with other users. The computing system may comprise a reprojection engine 303 to receive visual content input 301. The reprojection engine may be a late-latching reprojection engine. The visual content input 301 may comprise previously generated 2D video content to be played on an AR display device 110B worn by the first user 102, and virtual content rendered by a graphics processing unit (GPU) and custom graphics IPs. The virtual content may comprise a plurality of surfaces of each frame in an artificial reality scene. The plurality of surfaces may correspond to one or more specialized object primitives or images that are made into such surfaces by the reprojection engine 303, comprising location and texture data for one or more object primitives in the artificial reality scene. The reprojection engine 303 may receive the plurality of surfaces, update and refine their appearances to reflect changes in viewer perspective and/or accommodate display-device characteristics, finalize rendering and prepare the result for display to the user. The reprojection engine 303 may generate a projection image 305 for display by projecting the plurality of surfaces onto the real word environment or a scene based on an eye pose of the first user 102 such that the virtual content may appear aligned with the user's perspective and may create a more immersive and realistic experience. The GPU may render the plurality of surfaces at a low framerate (e.g., 30 fps, 45 fps), which may not match a high framerate (e.g., 90 fps) for the display. The reprojection engine 303 may project the plurality of surfaces and may generate the projection image 305 at a high framerate for display. Before sending the projection image 305 for display, the projected surfaces in the projection image 305 may display related corrections. As an example not by way of limitation, the contents displayed on the lens of the AR device may suffer from optical aberration such as distortion and chromatic aberration, which may cause the virtual content to appear distorted, blurred, and with color fringes. The reprojection engine 303 may send the projected surfaces in the projection image 305 to a display correction module 307 for distortion correction and/or chromatic aberration. The display correction module 307 may have a corrected image 309 sent to a display 311 for viewing by the first user.

In particular embodiments, the first user may capture and share the artificial reality scene during the display of the AR experience. The computing system 108 may access the plurality of surfaces in the artificial reality scene. The plurality of surfaces are projected for display to the first user based on the eye pose of the first user by the reprojection engine 303. The visual content input 301 may comprise the plurality of surfaces in the artificial reality scene received by the graphics and display subsystem 310. The computing system 108 may capture, using a camera 313 of the AR device worn by the first user, a frame 315 of the real-world environment while displaying the artificial reality scene to the first user. The captured frame of the real-world environment is associated with a camera pose 317. Additionally or alternatively, the AR capture system 320 may further comprise an image signal processor (ISP) 319 that may perform image processing such as noise reduction, color correction, and down sampling on raw image data of the captured frame 315. The ISP 319 may provide filtered captured frame 321 for further processing. Additionally or alternatively, the camera 313 may capture a video of the real-world environment, which may be processed by the ISP 319 for noise reduction and other video corrections. In particular embodiments, the computing system 108 may access the camera pose 317 associated with the captured frame 315 and may reproject the plurality of surfaces based on the camera pose 317. As an example not by way of limitation, the reprojection engine 303 of the computing system 108 may reproject the plurality of surfaces of the visual content input 301 and generate reprojected surfaces 323. The computing system 108 may generate, using a display control unit 325, an aligned artificial reality scene 327 based on the reprojected plurality of surfaces 323 and the captured frame 315 and/or the filtered captured frame 321 of the real-world environment. The plurality of surfaces initially associated with the user's eye pose may be aligned with the captured frame associated with the camera pose.

In particular embodiments, the computing system 108 may send the aligned artificial reality scene to a second user for display. The aligned artificial reality scene 327 may be encoded by a video encoder 329 prior to sending. Additionally or alternatively, the first user may share the aligned artificial reality scene 327 to one or more social media platforms for viewing by other users. In particular embodiments, microphone(s) 331 of the AR capture system may capture audio content input 333. The AR capture system 320 may further comprise an audio encoder 337 to encode the audio content input 333 and an AR system audio 335. As an example not by way of limitation. AR capture may include capturing user's audio, such as voice reactions to the visual content, the ambient voice of the real-world environment, and the AR system audio associated with the virtual content. The computing system may send AR experience 339, including the encoded aligned artificial reality scene 327 and encoded AR audio 333 and 335 to the second user and/or the social media platforms through a Cloud network 340.

In particular embodiments, the plurality of surfaces are associated with a first time stamp and the captured frame of the real-world environment is associated with a second time stamp that is different from the first time stamp. As an example not by way of limitation, the camera 313 may capture the captured frame 315 of the real-world environment at time T, and the virtual content that the first user may see at time T1 may be rendered based on a prediction of the virtual content due to system latency. The computing system 108 may determine the prediction of the virtual content based on the plurality of surfaces associated with a past time T−dt. The computing system 108 may use the camera pose recorded at time T to reproject the plurality of surfaces associated with user's eye pose rendered at time T−dt so that the aligned AR scene may be associated with identical camera pose at time T for both real-world environment and the virtual content. In particular embodiments, the camera 313 may have built-in stabilization functionalities. The computing system 108 may leverage the camera stabilization functionalities and share the stabilized camera pose that may be translated to the user's eye pose when reprojecting the plurality of surfaces to reduce the cost of image stabilization for the virtual content during AR capture. In particular embodiments, the computing system may determine to use one of the cameras on the AR device for capturing the real-world environment. The plurality of surfaces may be determined based on which camera is used for capturing. As an example not by way of limitation, the AR surfaces may be rendered previously for display on left and right lenses separately. The AR device may comprise a first camera located near the right eye and a second camera located near the left eye. When determining that the right-side camera is used for capturing, and the computing system may use the surfaces rendered for display on the right lens for the reprojection during AR capture.

In particular embodiments, the computing system 108 may previously render the plurality of surfaces at a first frame rate. The computing system 108 may reproject the plurality of surfaces at a second frame rate that is higher than the first frame rate. As an example not by way of limitation, the GPU and custom graphics IPs may render the plurality of surfaces of the virtual content at a low frame rate (e.g., 30 fps or 45 fps). When projecting the plurality of surfaces for displaying for the first user, the computing system 108 may project the plurality of surfaces based on the eye pose of the first user at a higher frame rate (e.g., 90 fps). Additionally or alternatively, the computing system 108 may reproject the plurality of surfaces based on the camera pose at the high frame rate for AR capture. The computing system 180 may add extra camera poses for reprojecting the AR capture when reprojecting the plurality of surfaces at the high frame rate for AR capturing and sharing so that a second user may fully experience the AR experience as the first user with high video qualities.

In particular embodiments, the computing system may disable one or more display corrections when reprojecting the plurality of surfaces based on the camera pose. The one or more display corrections may be enabled for projecting the plurality of surfaces for display to the first user based on the eye pose of the first user. In particular embodiments, the computing system 108 may reproject the plurality of surfaces into a two-dimensional rectilinear frame buffer based on the camera pose in a 2D AR capturing mode.

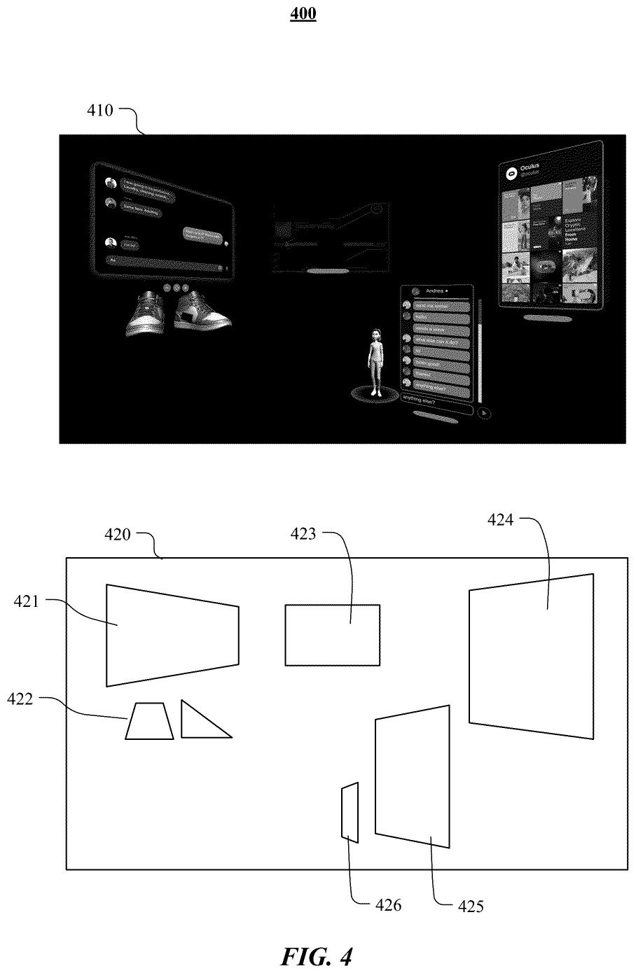

FIG. 4 illustrates an example two-dimensional (2D) AR capturing mode for storing AR surfaces. The computing system 108 may reproject the plurality of surfaces into a two-dimensional rectilinear frame buffer based on the camera pose. As an example not by way of limitation, the first user may capture a frame 410 with virtual objects, including a message application, a pair of virtual shoes, a music player, a user interface panel, a conversation box, and a human figure (e.g., a virtual assistant). The computing system 108 may reproject the surfaces message application surface 421, virtual shoes surface 422, music player surface 423, user interface panel surface 424, conversation box surface 425, and human figure surface 426 for each of the virtual object into a two-dimensional rectilinear frame buffer 420 based on the camera pose. The computing system 108 may access the 2D rectilinear frame buffer 420 and overlay the surfaces 421, 422, 423, 424, 425, and 426 to the captured real-word environment for 2D display. The surfaces may remain tilting degrees in the 2D capturing mode.

In particular embodiments, the computing system 108 may record positioning metadata associated with each of the plurality of surfaces. The positioning metadata may comprise a surface three-dimensional pose in the single frame buffer, a surface offset in the single frame buffer, a surface size in the single frame buffer, a surface scaling factor in the single frame buffer, head pose of the first user, eye pose of the first user, and a camera pose. In a 3D AR capturing mode, the computing system 108 may store the plurality of surfaces as textures to a single frame buffer. The computing system 108 may also store the positioning metadata for later use. When playback for the first user, the computing system 108 may reposition the stored plurality of surfaces based on the positioning metadata for three-dimensional playback. As an example not by way of limitation, the plurality of 2D and 3D surfaces may be all placed in a 2D image for encoding. The positioning metadata may indicate a particular portion of the 2D image corresponding to a particular surface of the plurality of 2D and 3D surfaces.

In particular embodiments, the computing system 108 may encode the single frame buffer and the positioning metadata and send the encoded single frame buffer and metadata to a second user for three-dimensional playback. In particular embodiments, the computing system may detect Digital rights management (DRM) in the plurality of surfaces, and the system may hide the detected DRM content when reprojecting the plurality of surfaces for sharing.

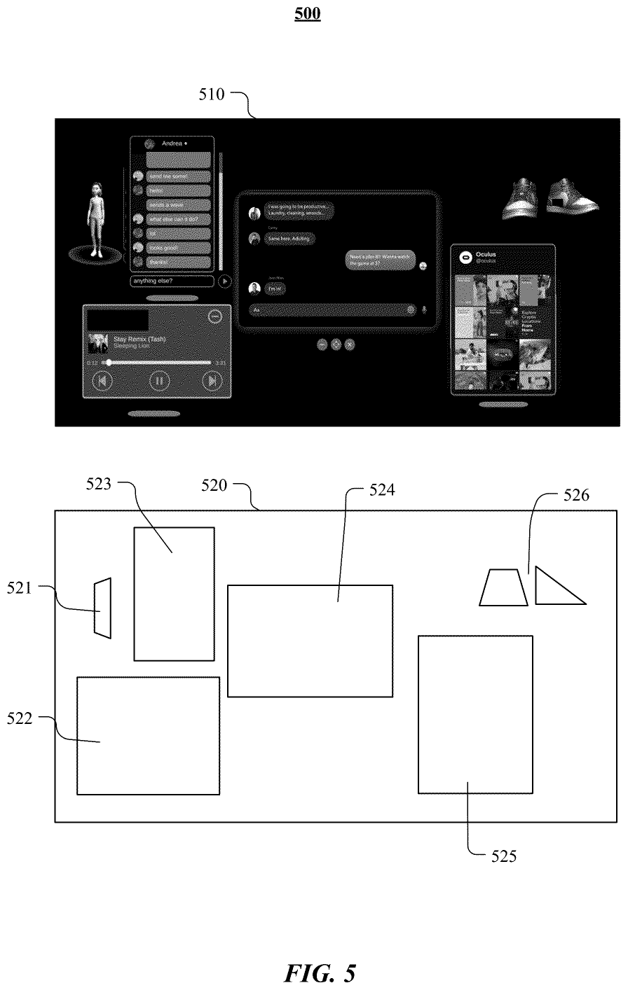

FIG. 5 illustrates an example three-dimensional (3D) AR capturing mode for storing AR surfaces. The computing system 108 may re-layout cach surface for the message application, virtual shoes, music player, user interface panel, conversation box, and human figure of FIG. 4 in a single frame buffer 510, 520 as textures. 2D and 3D surfaces may be used to recreate the virtual objects that may be overlaid onto the real-world environment. The single frame buffer 510, 520 may hold data associated with each surface before being rendered to the display. The surfaces 521. 522, 523, 524, 525, and 526 may be 2D composited surfaces. The computing system may record metadata relevant to the message application, virtual shoes, music player, user interface panel, conversation box, and human figure for each surface 521, 522, 523, 524, 525, and 526. The surfaces 521, 522, 523, 524, 525, and 526 and the recorded metadata may be played back to generate a 3D experience for users.

In particular embodiments, the plurality of surfaces may be interactable during the three-dimensional playback. As an example not by way of limitation, AR device users may interact with the virtual content reprojected based on the surfaces in six degrees of freedom, such as translation and rotation of the virtual content to view the virtual content from a different point of view for an enhanced 3D experience. Users using traditional 2D display devices like a smartphone or tablet may still be able to interact with the captured image or video. As an example not by way of limitation, the 2D device users may pause and playback, zoom in and zoom out the surfaces.

In particular embodiments, the computing system may use machine learning super-resolution techniques to enhance the image or video resolution of the captured AR content to reduce power consumption. As an example not by way of limitation, the computing system 108 may have the captured frame of the real-world environment and the reprojected frame buffer generated at a low resolution to reduce power, and may then apply the super-resolution technique to the aligned artificial reality scene for the first user and the second user.

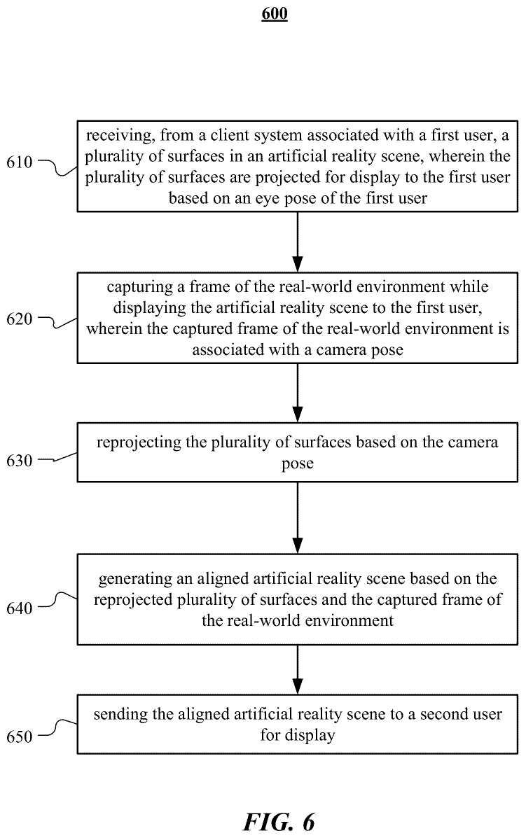

FIG. 6 illustrates an example method 600 for capturing AR scenes and sharing the captured AR scenes with other users. The method may begin at step 610, where the assistant system 140 may access from a client system associated with a first user, a plurality of surfaces in an artificial reality scene, wherein the plurality of surfaces are projected for display to the first user based on an eye pose of the first user. At step 620, the assistant system 140 may capture a frame of the real-world environment while displaying the artificial reality scene to the first user, wherein the captured frame of the real-world environment is associated with a camera pose. At step 630. the assistant system 140 may reproject the plurality of surfaces based on the camera pose. At step 640, the assistant system 140 may generate an aligned artificial reality scene based on the reprojected plurality of surfaces and the captured frame of the real-world environment. At step 650, the assistant system 140 may send the aligned artificial reality scene to a second user for display. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for capturing AR scenes and sharing the captured AR scenes with other users including the particular steps of the method of FIG. 6, this disclosure contemplates any suitable method for capturing AR scenes and sharing the captured AR scenes with other users including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

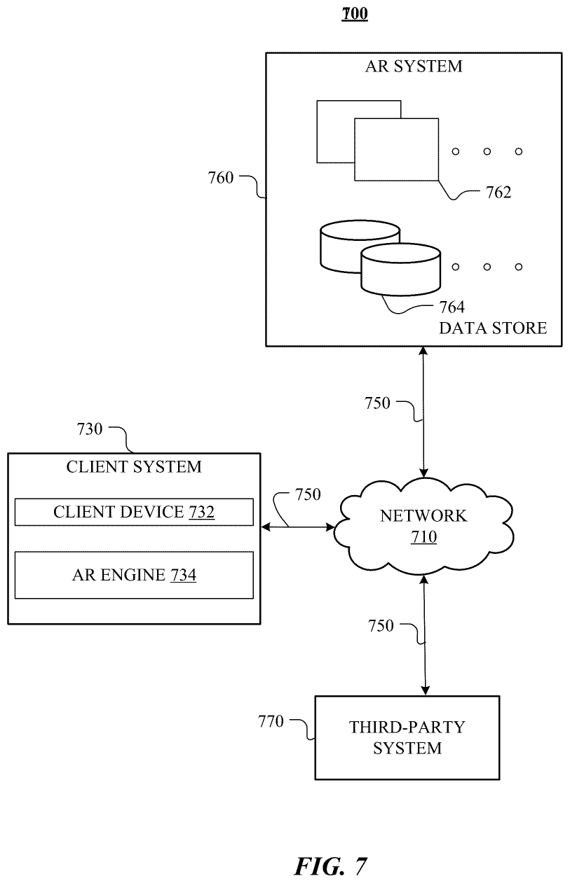

FIG. 7 illustrates an example network environment 700 associated with an AR system. Network environment 700 includes a client system 730, an AR system 760, and a third-party system 770 connected to each other by a network 710. Although FIG. 7 illustrates a particular arrangement of a client system 730, an AR system 760, a third-party system 770, and a network 710, this disclosure contemplates any suitable arrangement of a client system 730, an AR system 760, a third-party system 770, and a network 710. As an example and not by way of limitation, two or more of a client system 730, an AR system 760, and a third-party system 770 may be connected to each other directly, bypassing a network 710. As another example, two or more of a client system 730, an AR system 760, and a third-party system 770 may be physically or logically co-located with each other in whole or in part. Moreover, although FIG. 7 illustrates a particular number of client systems 730, AR system 760, third-party systems 770, and networks 710, this disclosure contemplates any suitable number of client systems 730, AR system 760, third-party systems 770, and networks 710. As an example and not by way of limitation, network environment 700 may include multiple client systems 730, AR systems 760, third-party systems 770, and networks 710.

This disclosure contemplates any suitable network 710. As an example and not by way of limitation, one or more portions of a network 710 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 710, or a combination of two or more such networks 710.

Links 750 may connect a client system 730, an AR system 760, and a third-party system 770 to a communication network 710 or to each other. This disclosure contemplates any suitable links 750. In particular embodiments, one or more links 750 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 750 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 750, or a combination of two or more such links 750. Links 750 need not necessarily be the same throughout a network environment 700. One or more first links 750 may differ in one or more respects from one or more second links 750.

In particular embodiments, a client system 730 may be any suitable electronic device including hardware, software, or embedded logic components, or a combination of two or more such components, and may be capable of carrying out the functionalities implemented or supported by a client system 730. As an example and not by way of limitation, the client system 730 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual reality (VR) headset, other suitable electronic device, or any suitable combination thereof. In particular embodiments, the client system 730 may be an AR device. This disclosure contemplates any suitable client systems 730. In particular embodiments, a client system 730 may enable a network user at a client system 730 to access a network 710. The client system 730 may also enable the user to communicate with other users at other client systems 730.

In particular embodiments, a client system 730 may include a client device 732. The client device 732 may include rendering device and, optionally, a companion device. The rendering device may be configured to render outputs generated by the AR system 760 to the user. The companion device may be configured to perform computations associated with particular tasks (e.g., communications with the AR system 760) locally (i.e., on-device) on the companion device in particular circumstances (e.g., when the rendering device is unable to perform said computations). In particular embodiments, the client system 730, the rendering device, and/or the companion device may each be a suitable electronic device including hardware, software, or embedded logic components, or a combination of two or more such components, and may be capable of carrying out, individually or cooperatively, the functionalities implemented or supported by the client system 730 described herein. As an example and not by way of limitation, the client system 730, the rendering device, and/or the companion device may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual reality (VR) headset, augmented-reality (AR) smart glasses, other suitable electronic device, or any suitable combination thereof. In particular embodiments, one or more of the client system 730, the rendering device, and the companion device may operate as a smart assistant device. As an example and not by way of limitation, the rendering device may comprise smart glasses and the companion device may comprise a smart phone. As another example and not by way of limitation, the rendering device may comprise a smart watch and the companion device may comprise a smart phone. As yet another example and not by way of limitation, the rendering device may comprise smart glasses and the companion device may comprise a smart remote for the smart glasses. As yet another example and not by way of limitation, the rendering device may comprise a VR/AR headset and the companion device may comprise a smart phone.

In particular embodiments, the client device 732 may comprise a web browser, and may have one or more add-ons, plug-ins, or other extensions. A user at a client system 730 may enter a Uniform Resource Locator (URL) or other address directing a web browser to a particular server (such as server 762, or a server associated with a third-party system 770), and the web browser may generate a Hyper Text Transfer Protocol (HTTP) request and communicate the HTTP request to server. The server may accept the HTTP request and communicate to a client system 730 one or more Hyper Text Markup Language (HTML) files responsive to the HTTP request. The client system 730 may render a web interface (e.g., a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, the client system 730 (e.g., an HMD) may include an AR engine 734 to provide the AR feature described herein, and may have one or more add-ons, plug-ins, or other extensions. A user at client system 930 may connect to a particular server (such as server 762, or a server associated with a third-party system 770). The server may accept the request and communicate with the client system 730.

In particular embodiments, the AR system 760 may be a network-addressable computing system. The AR system 760 may generate, store, receive, and send AR data, such as, for example, user profile data, concept-profile data, AR information, or other suitable data related to the AR system. The AR system 760 may be accessed by the other components of network environment 700 either directly or via a network 710. As an example and not by way of limitation, a client system 730 may access the AR system 760 using a head-mounted device or a native application associated with the AR system 760 (e.g., an AR game application, a video sharing application, another suitable application, or any combination thereof) either directly or via a network 710. In particular embodiments, the AR system 760 may include one or more servers 762. Each server 762 may be a unitary server or a distributed server spanning multiple computers or multiple datacenters. As an example and not by way of limitation, each server 762 may be a web server, a news server, a mail server, a message server, an advertising server, a file server, an application server, an exchange server, a database server, a proxy server, another server suitable for performing functions or processes described herein, or any combination thereof. In particular embodiments, each server 762 may include hardware, software, or embedded logic components or a combination of two or more such components for carrying out the appropriate functionalities implemented or supported by server 762. In particular embodiments, the AR system 760 may include one or more data stores 764. Data stores 764 may be used to store various types of information. In particular embodiments, the information stored in data stores 764 may be organized according to specific data structures. In particular embodiments, each data store 764 may be a relational, columnar, correlation, or other suitable database. Although this disclosure describes or illustrates particular types of databases, this disclosure contemplates any suitable types of databases. Particular embodiments may provide interfaces that enable a client system 730, an AR system 760, or a third-party system 770 to manage, retrieve, modify, add, or delete, the information stored in data store 764.

In particular embodiments, the AR system 760 may provide users with the ability to take actions on various types of items or objects, supported by the AR system 760. As an example and not by way of limitation, the items and objects may include groups or social networks to which users of the AR system 760 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the AR system 760 or by an external system of a third-party system 770, which is separate from the AR system 760 and coupled to the AR system 760 via a network 710.

In particular embodiments, the AR system 760 may be capable of linking a variety of entities. As an example and not by way of limitation, the AR system 760 may enable users to interact with each other as well as receive content from third-party systems 770 or other entities, or to allow users to interact with these entities through an application programming interfaces (API) or other communication channels.

In particular embodiments, a third-party system 770 may include one or more types of servers, one or more data stores, one or more interfaces, including but not limited to APIs, one or more web services, one or more content sources, one or more networks, or any other suitable components, e.g., that servers may communicate with. A third-party system 770 may be operated by a different entity from an entity operating the AR system 760. In particular embodiments, however, the AR system 760 and third-party systems 770 may operate in conjunction with each other to provide social-networking services to users of the AR system 760 or third-party systems 770. In this sense, the AR system 760 may provide a platform, or backbone, which other systems, such as third-party systems 770, may use to provide social-networking services and functionality to users across the Internet.

In particular embodiments, a third-party system 770 may include a third-party content object provider. A third-party content object provider may include one or more sources of content objects, which may be communicated to a client system 730. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. In particular embodiments, a third-party content provider may use one or more third-party agents to provide content objects and/or services. A third-party agent may be an implementation that is hosted and executing on the third-party system 770.

In particular embodiments, the AR system 760 also includes user-generated content objects, which may enhance a user's interactions with the AR system 760. User-generated content may include anything a user can add, upload, send, or “post” to the AR system 760. As an example and not by way of limitation, a user communicates posts to the AR system 760 from a client system 730. Posts may include data such as status updates or other textual data, location information, photos, videos, links, music or other similar data or media. Content may also be added to the AR system 760 by a third-party through a “communication channel,” such as a newsfeed or stream.

In particular embodiments, the AR system 760 may include a variety of servers, subsystems, programs, modules, logs, and data stores. In particular embodiments, the AR system 760 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The AR system 760 may also include suitable components such as network interfaces, security mechanisms, load balancers, failover servers, management-and-network-operations consoles, other suitable components, or any suitable combination thereof. In particular embodiments, the AR system 760 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the AR system 760 to one or more client systems 730 or one or more third-party systems 770 via a network 710. The web server may include a mail server or other messaging functionality for receiving and routing messages between the AR system 760 and one or more client systems 730. An API-request server may allow, for example, one or more computing systems 108 or a third-party system 770 to access information from the AR system 760 by calling one or more APIs. An action logger may be used to receive communications from a web server about a user's actions on or off the AR system 760. In conjunction with the action log, a third-party-content-object log may be maintained of user exposures to third-party-content objects. A notification controller may provide information regarding content objects to a client system 730. Information may be pushed to a client system 730 as notifications, or information may be pulled from a client system 730 responsive to a user input comprising a user request received from a client system 730. Authorization servers may be used to enforce one or more privacy settings of the users of the AR system 760. A privacy setting of a user may determine how particular information associated with a user can be shared. The authorization server may allow users to opt in to or opt out of having their actions logged by the AR system 760 or shared with other systems (e.g., a third-party system 770), such as, for example, by setting appropriate privacy settings. Third-party-content-object stores may be used to store content objects received from third parties, such as a third-party system 770. Location stores may be used for storing location information received from client systems 730 associated with users. Advertisement-pricing modules may combine social information, the current time, location information, or other suitable information to provide relevant advertisements, in the form of notifications, to a user.

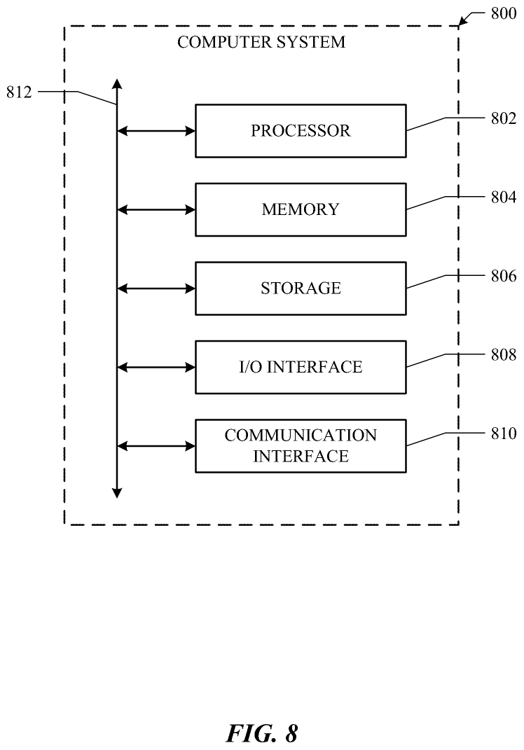

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCle) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
accessing, from a client system associated with a first user, a plurality of surfaces in an artificial reality scene, wherein the plurality of surfaces are projected for display to the first user based on an eye pose of the first user;
capturing a frame of the real-world environment while displaying the artificial reality scene to the first user, wherein the captured frame of the real-world environment is associated with a camera pose;
reprojecting the plurality of surfaces based on the camera pose;
generating an aligned artificial reality scene based on the reprojected plurality of surfaces and the captured frame of the real-world environment; and
sending the aligned artificial reality scene to a second user for display.

2. The method of claim 1, wherein the plurality of surfaces are associated with a first timestamp, wherein the captured frame of the real-world environment is associated with a second timestamp that is different from the first timestamp.

3. The method of claim 1, wherein the plurality of surfaces are previously rendered at a first frame rate, wherein the reprojected plurality of surfaces are generated at a second frame rate that is higher than the first frame rate.

4. The method of claim 1, wherein reprojecting the plurality of surfaces based on the camera pose further comprising:
disabling one or more display corrections when reprojecting the plurality of surfaces based on the camera pose, wherein the one or more display corrections are used for projecting the plurality of surfaces for display to the first user based on the eye pose of the first user; and
reprojecting the plurality of surfaces into a two-dimensional rectilinear frame buffer based on the camera pose.

5. The method of claim 1, further comprising:
recording positioning metadata associated with each of the plurality of surfaces;
storing the plurality of surfaces to a single frame buffer; and
repositioning the stored plurality of surfaces based on the positioning metadata for three-dimensional playback.

6. The method of claim 5, further comprising:
encoding the single frame buffer and the positioning metadata; and
sending the encoded single frame buffer and the encoded positioning metadata to a second user for three-dimensional playback.

7. The method of claim 5, wherein the positioning metadata comprises a surface three-dimensional pose in the single frame buffer, a surface offset in the single frame buffer, a surface size in the single frame buffer, a surface scaling factor in the single frame buffer, head pose of the first user, eye pose of the first user, and a camera pose.

8. The method of claim 5, wherein the plurality of surfaces are stored in a texture format.

9. The method of claim 5, wherein the plurality of surfaces are interactable during the three-dimensional playback.

10. One or more computer-readable non-transitory storage media embodying software that is operable when executed to:
access, from a client system associated with a first user, a plurality of surfaces in an artificial reality scene, wherein the plurality of surfaces are projected for display to the first user based on an eye pose of the first user;
capture a frame of the real-world environment while displaying the artificial reality scene to the first user, wherein the captured frame of the real-world environment is associated with a camera pose;
reproject the plurality of surfaces based on the camera pose;
generate an aligned artificial reality scene based on the reprojected plurality of surfaces and the captured frame of the real-world environment; and
send the aligned artificial reality scene to a second user for display.

11. The media of claim 10, wherein the plurality of surfaces are associated with a first timestamp, wherein the captured frame of the real-world environment is associated with a second timestamp that is different from the first timestamp.

12. The media of claim 10, wherein the plurality of surfaces are previously rendered at a first frame rate, wherein the reprojected plurality of surfaces are generated at a second frame rate that is higher than the first frame rate.

13. The media of claim 10, wherein the software is further operable when executed to:
disable one or more display corrections when reprojecting the plurality of surfaces based on the camera pose, wherein the one or more display corrections are used for projecting the plurality of surfaces for display to the first user based on the eye pose of the first user; and
reproject the plurality of surfaces into a two-dimensional rectilinear frame buffer based on the camera pose.

14. The media of claim 10, wherein the software is further operable when executed to:
record positioning metadata associated with each of the plurality of surfaces;
store the plurality of surfaces to a single frame buffer; and
reposition the stored plurality of surfaces based on the positioning metadata for three-dimensional playback.

15. The media of claim 14, wherein the software is further operable when executed to:
encode the single frame buffer and the positioning metadata; and
send the encoded single frame buffer and the encoded positioning metadata to a second user for three-dimensional playback.

16. The media of claim 14, wherein the positioning metadata comprises a surface three-dimensional pose in the single frame buffer, a surface offset in the single frame buffer, a surface size in the single frame buffer, a surface scaling factor in the single frame buffer, head pose of the first user, eye pose of the first user, and a camera pose.

17. The media of claim 14, wherein the plurality of surfaces are stored in a texture format.

18. A system comprising: one or more processors; and a non-transitory memory coupled to the processors comprising instructions executable by the processors, the processors operable when executing the instructions to:
access, from a client system associated with a first user, a plurality of surfaces in an artificial reality scene, wherein the plurality of surfaces are projected for display to the first user based on an eye pose of the first user;
capture a frame of the real-world environment while displaying the artificial reality scene to the first user, wherein the captured frame of the real-world environment is associated with a camera pose;
reproject the plurality of surfaces based on the camera pose;
generate an aligned artificial reality scene based on the reprojected plurality of surfaces and the captured frame of the real-world environment; and
send the aligned artificial reality scene to a second user for display.

19. The system of claim 18, wherein the processors are further operable when executing the instructions to:
record positioning metadata associated with each of the plurality of surfaces;
store the plurality of surfaces to a single frame buffer; and
reposition the stored plurality of surfaces based on the positioning metadata for three-dimensional playback.

20. The system of claim 19, wherein the positioning metadata comprises a surface three-dimensional pose in the single frame buffer, a surface offset in the single frame buffer, a surface size in the single frame buffer, a surface scaling factor in the single frame buffer, head pose of the first user, eye pose of the first user, and a camera pose.
